(19) United States
(12) Patent Application Publication
(10) Pub. No.: US 2024/0328950 A1
(43) Pub. Date: Oct. 3, 2024

(54) STABLE NIR ABSORBANCE AND FLUORESCENCE REFERENCE STANDARDS

(71) Applicant: Authentix, Inc., Addison, TX (US)

(72) Inventors: Philip B. FORSHEE, Addison, TX (US); John-Christopher BOYER, Addison, TX (US)

(21) Appl. No.: 18/596,204

(22) Filed: Mar. 5, 2024

Related U.S. Application Data
(60) Provisional application No. 63/450,835, filed on Mar. 8, 2023.

(51) Int. Cl. G01N 21/64

(52) U.S. Cl. CPC G01N 21/6458; G01N 2201/13

(57) ABSTRACT

A method of preparing a reference material for fluorescence spectroscopy by impregnating or otherwise placing one or more fluorophores into a solid polymethyl methacrylate (PMMA) matrix. The method can include impregnating or otherwise placing the one or more fluorophores into the solid PMMA matrix by melt mixing a powder of each of the one or more fluorophores with the solid PMMA matrix to provide a mixed product comprising a homogeneous distribution of the one or more fluorophores in the PMMA and injection molding the mixed product to provide the reference material having a final shape; and/or polymerizing MMA in the presence of one or more fluorophores to form the solid PMMA matrix.

### CROSS-REFERENCE TO RELATED APPLICATIONS

This application claims priority benefit under 35 U.S.C. 119(e) of U.S. Provisional Patent Application Ser. No. 63/450,835 (filed Mar. 8, 2023), which is incorporated by reference herein in its entirety.

### BACKGROUND

Molecular spectroscopy involves the measurement of the interactions between electromagnetic waves and matter. Within this realm of spectroscopy, several different analytical techniques have been developed over the years to enable the measurement of all types of matter with the nearly all wavelengths of electromagnetic radiation. Two of these techniques include Visible/Near Infrared (Vis/NIR) absorbance and fluorescence spectroscopies. The present disclosure is directed to accurately measure the absorbance and fluorescence of compounds and instrumentation to detect these compounds in the wavelength range of 600-900 nm. In all forms of molecular spectroscopy, the proper calibration of the instrumentation is vital to ensuring both precise and accurate analysis results. Typically, this is accomplished by using Standard Reference Materials (SRMs) for both calibrating and verifying the performance of instrumentation. In a laboratory setting there are several established options for calibration, which typically involves dissolving a fluorescent material in an appropriate solvent at a specific concentration or utilizing a standardized light source from a calibrated lamp. While the use of solvent-based liquid standards is often standard practice for in-laboratory analysis, these standards once prepared have a relatively short useful shelf life as a result of solvent evaporation as well as photo-instability or photobleaching, which is the case for many organic absorbers/fluorophores. These limitations are more problematic for analysis conducted in a non-laboratory setting.

Moreover, for fluorescence spectroscopy, most of the optical reference standards previously developed and on the market today are designed for laboratory-based instruments that typically have variable-wavelength excitation sources based on the combination of xenon flash lamps and a monochromator, which enable the user to select the appropriate excitation wavelength for the available reference materials. However, most field-based fluorescence instrumentation is more specialized and optimized for purpose. It often contains either narrow band LED or laser-based excitation sources that are not matched for most of the SRMs available in the market.

Advances in modern instrumentation have enabled the development of portable instrumentation that can be taken out to the field. This enables results to be acquired faster and more efficiently. Field analysis also eliminates the need for transportation of samples back to laboratories, shipping limitations due to flammability, etc. Further, it also eliminates many concerns with possible contamination from sample handling and/or degradation of samples that are inherent unstable. However once in the field, the conveniences afforded in a laboratory environment for sample preparation are lost and the accurate preparation of liquid-based standards becomes near impossible, and the use of calibration lamps is impractical. Therefore, the development of a novel class of standard reference materials that could circumvent the logistical challenges presented by field-based sample analysis by untrained personnel would be highly advantageous.

### BRIEF DESCRIPTION OF THE DRAWINGS

FIG. 1 is a graph depicting results of a sunlight stability test where a solution of 2,9,16,23-tetrakis(2,5-di-tert-butyl-4-methoxyphenoxy)phthalocyanine in 1,3,5-trimethyl benzene (Current Liquid Standard) was stored outdoors in direct sunlight alongside a sample of the same phthalocyanine suspended in a (e.g., solid) polymethyl methacrylate (PMMA) matrix;

FIG. 2 is a graph depicting results of repeated analysis of a PMMA-based standard containing 200 ppb of 2,9,16,23-tetrakis(2,5-di-tert-butyl-4-methoxyphenoxy)phthalocyanine in a laser diode-based fluorometer (638 nm, 40 mW excitation source); dotted lines ( . . . . . ) represent a control line at +/−2% of mean signal, and dashed lines (-----) represent a control line at +/−5% of mean signal;

FIG. 3 illustrates a spectrometer, according to embodiments of this disclosure.

### DESCRIPTION

Herein disclosed is a robust reference standard for a fluorescence spectrometer (that can be used in the field and/or the lab) for measuring fluorescent chemical markers added to petroleum products. Such instrumentation can be utilized by both government fuel inspection agents and gas station owners to ensure the authenticity and/or tax compliance of fuels throughout the supply chain. Both groups are assumed to have little to no background experience or training in proper chemical handling techniques; therefore the known limitations of conventional liquid fluorescence standards would be highly problematic.

Commercially available polymethyl methacrylate (PMMA) based standards incorporate a few organic fluorophores that emit down in the visible region of electromagnetic spectrum. For example, UK Patent 2,525,953 teaches the inclusion of ultraviolet/visible fluorophores in PMMA for the purpose of validating polymerase chain reaction (PCR) apparatus for DNA replication. However, unlike the herein disclosed reference standard, existing products are not commercially available in the region of light stable, solid fluorescence standards that emit in the 700-900 nm range and are photostable to 638 nm laser-based excitation.

The herein disclosed process is compatible with the specific fluorophores (e.g., phthalocyanine-based fluorophores) used as fuel markers for the LSX series of portable field analyzers available from Authentix of Addison, TX. It was unexpectedly discovered that conventional catalysts used in PMMA synthesis, such as benzoyl peroxide, can be incompatible with fluorophores of interest (e.g., fluorophores that are compatible with the LSX platform). As detailed in Comparative Example 1 hereinbelow, attempts to polymerize methyl methacrylate (MMA) with fluorophores of interest in the presence of benzoyl peroxide resulted in no marker being detectable in the PMMA post polymerization. Without being limited by theory, it is speculated that the benzoyl peroxide radicals degraded the fluorophore during the polymerization reaction. The herein disclosed method enables production of reference standards that are stable (e.g., that, for at least 1, 2, 3 or more weeks, maintain greater than about 90% of a fluorophore signal intensity of the reference standard at time zero of preparing the reference standard).

Herein disclosed is a method comprising preparing a reference material for fluorescence spectroscopy. The method can comprise preparing the reference material for fluorescence spectroscopy by: impregnating or otherwise placing one or more fluorophores into a solid polymethylmethacrylate (PMMA) matrix.

In embodiments, impregnating or otherwise placing the one or more fluorophores into the solid PMMA matrix can be effected by melt mixing (e.g., extruding, melt compounding). A powder of each of the one or more fluorophores can be melt mixed with the solid PMMA matrix to provide a mixed product comprising a homogeneous distribution of the one or more fluorophores in the PMMA. The solid PMMA matrix can be in molten form when combined with the (e.g., powder(s) of the) one or more fluorophores. The solid PMMA matrix can comprise a virgin PMMA matrix (i.e., containing no fluorophores). The solid PMMA matrix can be in pellet form, and melted for combining with the one or more fluorophores. The mixed product can also comprise pellets, in embodiments, and can also be referred to herein as a “pellet”.

Without being limited by theory, containing the fluorophore(s) in a solid matrix, according to embodiments of the reference standard provided herein, may reduce excited state degradation by reducing collisions/movement of excited molecules with other molecules relative to liquid reference standards within which the fluorophore(s) can more freely move.

Melt mixing can comprise compound extrusion. In such embodiments, a compounding extruder can be utilized to combine the one or more fluorophores with the PMMA. A single or twin-screw compounding extruded can be utilized for the extrusion.

The method can further comprise injection molding the mixed product (e.g., the extruded/compounded product) to provide the reference material having a final shape. The final shape can be a shape designed to fit a spectrometer. For example, in embodiments, the final shape can comprise a cuvette shape. In embodiments, the shape can include a handle for handling and/or labeling the reference standard. Accordingly, the PMMA-based reference standards can be molded or shaped to whatever sample holder is appropriate for the instrument, for example, and without limitation, a rectangular shape mimicking a cuvette, or cylindrical shape mimicking a sample vial.

The melt mixing can further comprise: melt mixing the solid PMMA matrix (e.g., virgin PMMA matrix) and an amount of a powder of each of the one or more fluorophores to provide an intermediate product having a first concentration of the one or more fluorophores, wherein the first concentration is greater than a concentration of the one or more fluorophores in the reference standard; and melt mixing the intermediate product with additional solid PMMA matrix (e.g., virgin PMMA matrix) one or more times to provide the mixed product having the concentration of the one or more fluorophores in the reference standard, and the homogeneous distribution of the one or more fluorophores in the PMMA. The process of combining intermediate product with additional solid PMMA can be performed until a desired concentration (e.g., the concentration of the one or more fluorophores in the reference standard) is obtained in the reference standard. The desired concentration of each of the one or more fluorophores in the reference standard can be in a range of from about 0.1 part per billion (ppb) to 10,000 ppb, from about 0.1 ppb to 5,000 ppb, from about 0.1 ppb to 1,000 ppb, from about 0.1 ppb to 500 ppb, from about 0.1 ppb to 100 ppb, from about 0.1 ppb to 50 ppb, or from about 0.1 ppb to 10 ppb. The desired concentration of each of the one or more fluorophores in the reference standard can be in a range of from about 0.1, 0.2, 0.3, 0.4, 0.5, 0.6, 0.7, 0.8, 0.9, or 1 ppb to about 10000, 9000, 8000, 7000, 6000, 5000, 4000, 3000, 2000, 1000, 900, 800, 700, 600, 500, 400, 300, 200, 100, 90, 80, 70, 60, 50, 40, 30, 20, 10, 9, 8, 7, 6, 5, 4, 3, 2, 1, 0.5, 0.4, 0.3, 0.2, or 0.15 ppb.

For example, in embodiments, 1 wt % of the fluorophore is combined with 99 wt % virgin PMMA and compounded to provide a first intermediate having a first homogeneous concentration of the fluorophore therein. An amount (e.g., 1 wt %) of the first intermediate can be combined with 99 wt % of additional virgin PMMA matrix and compounded to provide a second intermediate having a second homogeneous concentration of the fluorophore. The process can be repeated until the desired concentration of the fluorophore(s) in the reference standard is attained. That is, the process of combining the intermediate with the additional virgin PMMA and compounding to provide the homogeneous concentration of fluorophore(s) in the intermediate can be performed until the concentration of the fluorophore in the intermediate equals the target/desired concentration (e.g., the fluorophore concentration of the reference standard concentration), at which time the reference standard has been obtained (e.g., this intermediate product is the reference standard).

In embodiments, the reference standard comprises at least two (e.g., different) fluorophores (e.g., having a different spectral window). For example, multiple absorbers/fluorophores can be incorporated into a single reference standard for assessing multiple wavelengths in a single analysis. In embodiments, the use of the two fluorophore compounds can allow for calibration of testing equipment where the equipment is utilized to detect fuel containing two different marker compounds.

In embodiments, melt mixing can comprises: concomitantly melt mixing (e.g., extruding) a powder of each of the two or more fluorophores with the solid PMMA matrix (e.g., virgin PMMA matrix) to provide the mixed product comprising the homogeneous distribution of the two or more fluorophores in the PMMA.

Alternatively or additionally, melt mixing in the case of at least two fluorophores can comprise: providing a first mixed product (e.g., a first pellet) having a homogeneous distribution of a first of the two or more fluorophores in the PMMA; providing a second mixed product (e.g., a second pellet) comprising a homogeneous distribution of a second of the two or more fluorophores in the PMMA; and melt mixing the first mixed product and the second mixed product, optionally in the presence of additional solid PMMA matrix (e.g., virgin PMMA), to provide the mixed product (e.g., a product pellet) comprising the homogeneous distribution of the two or more fluorophores in the PMMA. In such embodiments, the method can further comprise providing the first mixed product by melt mixing (e.g., extruding) a powder of a first of the two or more fluorophores with the solid PMMA matrix to provide the first mixed product; and providing the second mixed product by melt mixing a powder of a second of the two or more fluorophores with the solid PMMA matrix to provide a second mixed product.

In embodiments, pellets pre-mixed with certain fluorophores (e.g., mixed products, each comprising one or more fluorophores) can be compounded. Such pre-dosed or mixed products can then be custom combined for compounding, to let down (e.g., dilute) the amount of fluorophore(s), etc. The pre-mixed pellets can be utilized to facilitate the production of a particular reference standard for a subsequent analysis. The pre-dosed pellets can have a higher concentration of the one or more fluorophores than the reference standards produced therefrom. For example, the pre-dosed pellets can have a concentration in a range of from about 0.5 to 200, 50 to 200, 100 to 200, or 0.5 to 500 ppb, in embodiments. In embodiments, the pre-dosed pellets can have a concentration in a range of from about 0.5, 1, 10, 50, 100, 200, or 300 to about 50, 100, 200, 300, 400, or 500 ppb

The method of this disclosure can further comprise: calibrating a fluorescence spectroscopy instrument by: exciting the fluorescence spectroscopy reference material with energy emitted form an excitation source of the fluorescence spectroscopy instrument, and detecting, with the fluorescence spectroscopy instrument, emission of electromagnetic radiation at a wavelength between 600-900 nm from the excited fluorescence spectroscopy reference material. In embodiments (e.g., when the reference standard comprises two or more fluorophores), the method can further comprise: calibrating a fluorescence spectroscopy instrument by: exciting the fluorescence spectroscopy reference material with energy emitted form an excitation source of the fluorescence spectroscopy instrument, and detecting, with the fluorescence spectroscopy instrument, emission of electromagnetic radiation at two or more wavelengths between 600-900 nm from the excited fluorescence spectroscopy reference material.

In embodiments, impregnating or otherwise placing one or more fluorophores into the solid PMMA matrix further comprises polymerizing MMA in the presence of one or more fluorophores to form the solid PMMA matrix.

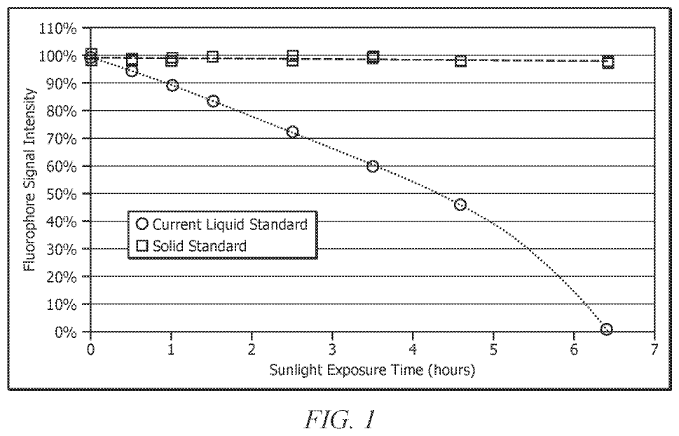

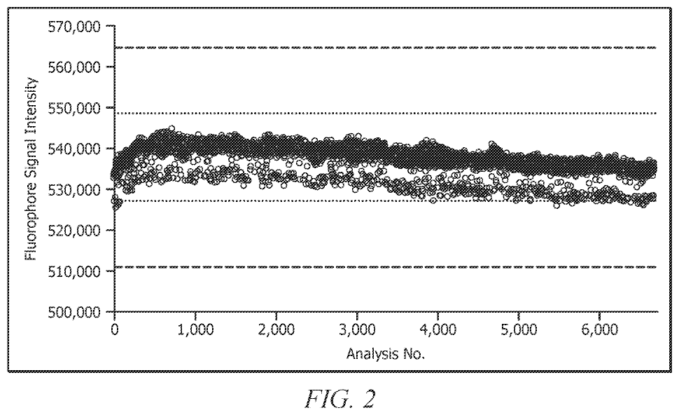

Polymerizing can further comprise initiating polymerization with an azo-based initiator. The azo-based initiator can comprise 1,1′-azobis(cyclohexanecarbonitrile) (ABCN); azobisisobutyronitrile (AIBN); 2,2′-Azobis (2,4 dimethylvaleronitrile) (ABVN); 2,2′-Azobis(2-methylbutyronitrile); 2,2′-Azobis(4-methoxy-2,4-dimethylvaleronitrile); 4,4′-Azobis(4-cyanovaleric acid); or a combination thereof. As discussed further hereinbelow in the EXAMPLES and with reference to FIG. 1, which is a graph depicting results of a sunlight stability test, and FIG. 2, which is a graph depicting results of repeated analyses with a PMMA-based reference standard in a laser diode-based fluorometer, it has been unexpectedly discovered that, using the milder azo-based initiators (also referred to as catalysts) resulted in successful incorporation of the fluorophores in the PMMA matrix. As discussed in the EXAMPLES, it has been unexpectedly discovered that the reference standard/material of this disclosure is stable to light (e.g., sunlight) exposure, while polymerization of MMA in the presence of benzoyl peroxide does not provide a stable reference standard/material.

The method of this disclosure can further comprise dissolving the one or more fluorophores in the MMA prior to the polymerizing. The polymerizing be effected to yield, as the reference standard, the solid PMMA matrix having the one or more fluorophores distributed (e.g., uniformly) therein.

As described hereinabove with reference to compounding, in embodiments, two or more fluorophores can be polymerized into the solid PMMA matrix to provide the reference standard.

The one or more fluorophores can emit in the near infrared/infrared region. For example, in embodiments, the one or more fluorophores can emit in the range of from about 600 to about 900 nm, from about 650 to about 900 nm, or from about 700 to about 900 nm range. The one or more fluorophores can comprise any fluorophores that emit in the aforementioned range. In embodiments, the one or more fluorophores comprise a phthalocyanine-based fluorophore and/or another fluorophore(s) that emit(s) in the 600 to 900 nm range, including, but not limited to, naphthalocyanines, violanthrones, aza-dipyrromethenes, or others. In embodiments, the one or more fluorophores comprise naphthalocyanines, violanthrones, aza-dipyrromethenes, or a combinations thereof. In embodiments, the one or more fluorophores comprise at least one phthalocyanine-based fluorophore. In embodiments, the one or more fluorophores comprise 2,9,16,23-tetrakis(2,5-di-tert-butyl-4-methoxyphenoxy)phthalocyanine.

Examples of suitable fluorophores include, but are not limited to Structure 1, Structure 2, Structure 3, Structure 4, or combinations thereof:

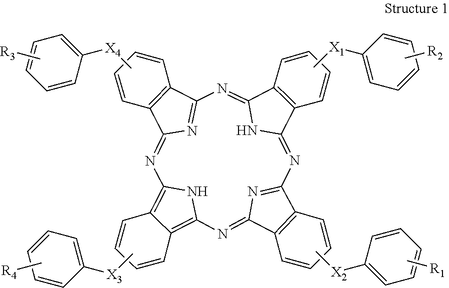

where X₁-X₄ is independently oxygen or sulfur and where R₁-R₄ is independently hydrogen, an alkyl group, a branched alkyl group, an alkoxy group, a branched alkoxy group.

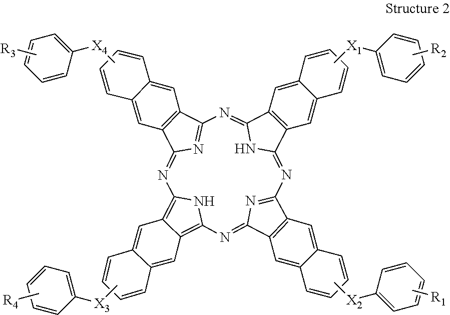

where X₁-X₄ is independently oxygen or sulfur and where R₁-R₄ is independently hydrogen, an alkyl group, a branched alkyl group, an alkoxy group, a branched alkoxy group.

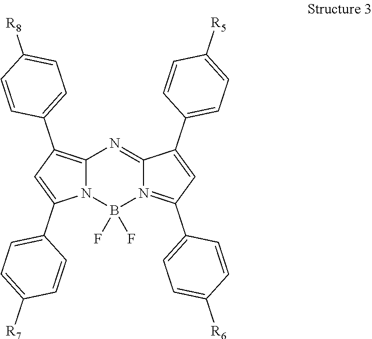

where R₅-R₈ is independently hydrogen, an alkyl group, a branched alkyl group, an alkoxy group, a branched alkoxy group, an amino group, an alkylamino group, a dialkylamino group, a thiol group, an alkylthio group, a branched alkylthio group, a halide group, or a nitro group.

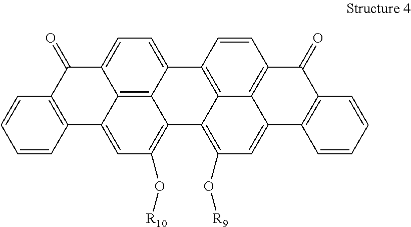

where R₉-R₁₀ is independently hydrogen, an alkyl group, a branched alkyl group, or a cycloalkyl group.

Thus, in embodiments, the one or more fluorophores comprise one or more fluorophores of Structure 1, one or more fluorophores of Structure 2, one or more fluorophores of Structure 3, one or more fluorophores of Structure 4, or a combination thereof.

Typical properties of a suitable PMMA are provided in Table 1, which provided properties of PMMA PLEXIGLAS® VS-100, available from Roehm America, LLC. The PMMA of this disclosure can comprise a PMMA having properties such as depicted in Table 1, or having one or more properties within about 1, 5, or 10% of those in Table 1. The PMMA can be transparent and can exhibit chemical resistance, clarity, color stability, thermal stability, UV resistance, and weather resistance.

TABLE 1
Example PMMA Data Sheet of Typical Properties
ASTM and ISO Properties

| | Nominal Value Unit | | Test Method |
|---|---|---|---|
| Physical | | | |
| Density-Specific Gravity | 1.18 sp gr 23/23° C. | | ASTM D792 |
| Melt Mass-Flow Rate (MFR) | 27.0 g/10 min | | ASTM D1238 |
| (230° C./3.8 kg) | | | |
| Mold shrink, Linear-Flow | 0.0020 to | | ASTM D955 |
| | 0.0060 in/in | | |
| Water Absorption @ 24 hrs | 0.30% | | ASTM D570 |
| Mechanical | | | |
| Tensile Modulus | 420000 | psi | ASTM D638 |
| Tensile Strength @ Yield | 9400 | psi | ASTM D638 |
| Tensile Elongation @ Break | 3.0% | | ASTM D638 |
| Flexural Modulus | 420000 | psi | ASTM D790 |
| Flexural Strength | 14000 | psi | ASTM D790 |
| Impact | | | |
| Notched Izod Impact (73° F.) | 0.300 | ft-lb/in | ASTM D256 |
| Hardness | | | |
| Rockwell Hardness (M-Scale) | 84 | | ASTM D785 |
| Thermal | | | |
| DTUL @66 psi- Annealed | 177° | F. | ASTM D648 |
| DTUL @264 psi- Annealed | 169° | F. | ASTM D648 |
| Max. Continuous Use Temp | 145 to 170° | F. | ASTM D794 |
| Glass Transition Temp | 196° | F. | ASTM E1356 |
| Vicat Softening Point | | | ASTM D1525 |
| (Rate A, Loading 2 (50N)) | 189° | F. | |
| (Rate A, Loading 1 (10N)) | 178° | F. | |

| | | |
|---|---|---|
| Thermal Conductivity | 1.3 BTU-in/hr/ft²/° F. | ASTM C177 |
| Flammability | | |
| Flame Rating- UL (0.0580 in) | HB | UL 94 |
| Optical | | |
| Refractive Index | 1.490 | ASTM D542 |
| Transmittance | 92.0% | ASTM D1003 |
| Haze | 2.0% | ASTM D1003 |

Additional Properties
ASTM Classification, ASTM D788: PMMA 0111V7
Processing Information

| Injection | Nominal Value Unit | |
|---|---|---|
| Drying Temperature | 180° | F. |
| Drying Time | 1.0 to 4.0 | hr |
| Rear Temperature | 360° | F. |
| Middle Temperature | 370° | F. |
| Front Temperature | 380° | F. |
| Nozzle Temperature | 370° | F. |
| Mold Temperature | 130 to 190° | F. |
| Injection Pressure | 15000 | psi |
| Back Pressure | 100 to 200 | psi |

The PMMA can be a product of the catalytic polymerization of methyl methacrylate (MMA). In embodiments, the polymerization catalyst comprises an azo-based initiators. As noted hereinabove, examples of suitable azo-based initiators include but are not limited to 1,1′-azobis(cyclohexanecarbonitrile) (ABCN); azobisisobutyronitrile (AIBN); 2,2′-Azobis (2,4 dimethylvaleronitrile) (ABVN); 2,2′-Azobis(2-methylbutyronitrile); 2,2′-Azobis(4-methoxy-2,4-dimethylvaleronitrile); 4,4′-Azobis(4-cyanovaleric acid); or combinations thereof. The polymerization can comprise a thermal polymerization mechanism.

In embodiments, the reference standard of this disclosure maintains, after a time period of at least 1, 2, 3 or more weeks (e.g., 1, 2, 3, 4, 5, or ten years, or indefinitely), maintain greater than about 90% of a fluorophore signal intensity of the reference standard at time zero of preparing the reference standard.

weeks, greater than about 90% of a fluorophore signal intensity thereof at time zero, wherein time zero is a time of preparing the reference standard. That is, if the reference standard exhibits an initial fluorophore signal intensity upon creation, the reference standard maintains at least 90% of that initial signal intensity after the time period.

Also provided herein is a fluorescence spectroscopy reference material prepared by the herein described method.

Further provided herein is a fluorescence spectroscopy reference material comprising a solid PMMA matrix having one or more fluorophores distributed (e.g., uniformly/homogeneously) and sequestered therein.

Also provided herein is a method of calibrating a fluorescence spectroscopy instrument. The method can comprise: exciting, with energy emitted form an excitation source, a fluorescence spectroscopy reference material described herein (e.g., produced by: impregnating or otherwise placing one or more fluorophores into a solid PMMA matrix, as described herein); and detecting, with the fluorescence spectroscopy instrument, emission of electromagnetic radiation at a wavelength between 600-900 nm from the excited fluorescence spectroscopy reference material.

The excitation source can comprise a laser or narrow band LED. In embodiments, the excitation source comprise a 638 nm laser diode. The fluorescence spectroscopy instrument can be a portable, field usable device suitable for use outside a laboratory environment. In embodiments, the fluorescence spectroscopy instrument is a field portable analytical device substantially as described in U.S. Pat. No. 9,995,681, the disclosure of which is hereby incorporated herein in its entirety for purposes not contrary to this disclosure.

The method can comprise calibrating the fluorescence spectroscopy instrument in the field or in a laboratory. In embodiments, the method can comprise calibrating the fluorescence spectroscopy instrument in the field (i.e., not in a lab setting) for use in the field. Once calibrated, the fluorescence spectroscopy instrument can be utilized in the field to analyze one or more samples. In embodiments, an initial analysis determined via field testing can be confirmed in a laboratory.

As noted above, impregnating or otherwise placing one or more fluorophores into the solid PMMA matrix to provide the fluorescence spectroscopy reference material can further comprise: melt mixing (e.g., extruding, melt compounding) a powder of each of the one or more fluorophores with the solid PMMA matrix to provide a mixed product comprising a homogeneous distribution of the one or more fluorophores in the PMMA; and injection molding the mixed product to provide the reference material having a final shape. Alternatively, impregnating or otherwise placing one or more fluorophores into the solid PMMA matrix to provide the fluorescence spectroscopy reference material can further comprise: polymerizing MMA in the presence of one or more fluorophores to form the solid PMMA matrix.

Also disclosed herein is a calibrated spectroscopy instrument resulting from the method of calibrating.

In embodiments, multiple concentrations of reference standard (e.g., multiple reference standards, each having an associated concentration of the one or more fluorophores) can be manufactured to produce a response curve for a given material. These multiple reference standards can be utilized to aid in device-to-device calibration.

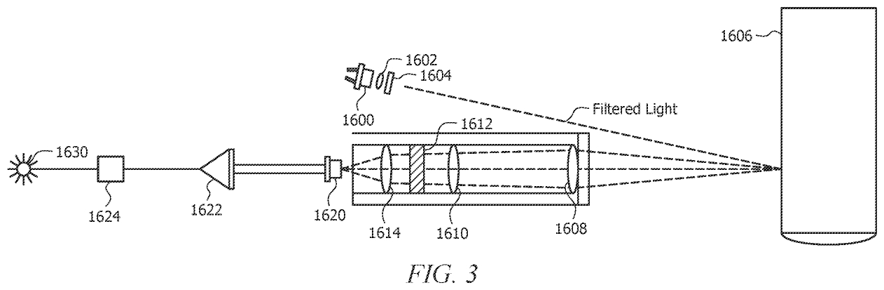

By way of example, in embodiment the fluorescence spectrometer is an instrument as depicted in FIG. 3, which illustrates an apparatus useful for detecting, identifying, and/or quantifying dye in a marked petroleum product. The apparatus has a laser diode light source 1600, which may emit radiation in the near infrared region. The light from the laser diode light source 1600 may be collimated through a collimating lens 1602, may pass through a filter 1604, and may then illuminate the marked petroleum product 1606. Thereafter, the light may pass through a focusing lens 1608, followed by a first compressing lens 1610, a filter 1612, and then a second compressing lens 1614. The angle between the light striking the petroleum product 1606 and the focusing lens, compressing lenses and filter may define an angle of about 30 degrees or less, which tends to minimize scattered light. After passing through the second compressing lens, the light may strike a photodetector 1620. The signal from the photodetector 1620 may be amplified with a current-to-voltage converter 1622. The output from the amplifier 1622 may then be detected by a threshold detector 1624, which may be configured to minimize any interference from unmarked materials. Furthermore, the presence of a dye or dyes may be indicated by a light-emitting diode (LED) indicator 1630.

Further provided herein is a method for analyzing a product. The method comprises utilizing the fluorescence spectroscopy reference material/standard of this disclosure. In embodiments, the method comprises: sampling the product (e.g., a composition) to obtain a test sample; and analyzing the test sample with the calibrated spectroscopy instrument, wherein the calibrated spectroscopy instrument was calibrated by: exciting, with energy emitted form an excitation source, a fluorescence spectroscopy reference material produced by: impregnating or otherwise placing one or more fluorophores into a solid PMMA matrix; and detecting, with the fluorescence spectroscopy instrument, emission of electromagnetic radiation at a wavelength between 600-900 nm from the excited fluorescence spectroscopy reference material.

The method can further comprise, based on the analyzing, (i) determining or authenticating a source of the product (e.g., for authentication purposes to detect counterfeit products), (ii) determining if the product is adulterated or diluted, or (iii) both (i) and (ii). For example, in embodiments, the product is a marked fuel, and (i), (ii), or III) can further comprise determining an amount of marker present in the marked fuel, a type of marker present in the marked fuel, or both the amount of marker present in the marked fuel and the type of marker present in the marked fuel.

In embodiments, one or more reference standard(s) of this disclosure can be incorporated them directly into the fluorescence spectroscopy instrument. In such embodiments, a small standard block can be affixed to a sliding or spring-loaded mechanism placing the sample in the optical path of the analyzer when no sample is loaded into the instrument. The action of inserting a cuvette or sample into the instrument (e.g., for analyzing a sample) can displace the reference standard from the optical analysis path, thus leaving the unknown sample to be analyzed in the optical pathway. As the unknown sample or cuvette is removed, the mechanism can return the reference standard to the optical path. In this manner, the instrument could be deemed to be operating within the specified ranges either prior to and/or after the analysis of the unknown sample.

To facilitate a better understanding of the present embodiments, the following examples of certain aspects of some embodiments are given. In no way should the following examples be read to limit, or define, the entire scope of the embodiments.

### EXAMPLES

### Comparative Example 1

In this Comparative Example 1, a concentrate of phthalocyanine was incorporated into a PMMA polymerization process. Multiple prototype batches of PMMA were created and analyzed, and initial production trials failed to exhibit any fluorescence signal from the phthalocyanine.

After critical review of the production process and chemistry involved, it was concluded that the most likely reason for the lack of fluorescence signal from the PMMA blocks produced was the use of benzoyl peroxide as the catalyst to initiate the MMA polymerization. Without being limited by theory, the benzoyl peroxide may either directly react with or catalyze the degradation of the phthalocyanine under the thermal conditions of the polymerization.

Subsequent investigations also identified an additional element related to the creation of photostable phthalocyanine doped PMMA standards. During experiments to optimize the thermal conditions necessary for polymerization, it was discovered that incomplete polymerization of the MMA was possible, and this resulted in PMMA standards that would degrade in sunlight to some extent that was proportional to the extent of MMA polymerization. In these cases, a solid block of PMMA was still formed, but upon analysis samples by Raman spectroscopy some MMA was still present in the polymer matrix. These samples exhibited a drop off in phthalocyanine fluorescence intensity upon exposure to sunlight which would plateau at some point after which the remaining phthalocyanine would remain photostable.

### Example 2

Experiments were performed that dissolved 2,9,16,23-tetrakis(2,5-di-tert-butyl-4-methoxyphenoxy)phthalocyanine into methyl methacrylate (MMA) and polymerized this solution to form polymethyl methacrylate (PMMA) using 1,1′-azobis(cyclohexanecarbonitrile) (ABCN) as the catalyst through a thermal polymerization mechanism. The product of this reaction proved to be stable to direct sunlight for extended periods of time, unlike a polymerization product (e.g., of Comparative Example 1) formed in the presence of a simple solution of the phthalocyanine. FIG. 1 is a graph depicting the results of a sunlight stability test where a solution of 2,9,16,23-tetrakis(2,5-di-tert-butyl-4-methoxyphenoxy)phthalocyanine in 1,3,5-trimethyl benzene (Current Liquid Standard) was stored outdoors in direct sunlight alongside a sample of the same phthalocyanine suspended in a (e.g., solid) polymethyl methacrylate (PMMA) matrix (Solid Standard) according to this disclosure. FIG. 1 depicts the fluorophore signal intensity of the comparative Current Liquid Standard and the Solid Standard of this disclosure as a function of sunlight exposure time (hours). As seen in FIG. 1, the fluorophore signal intensity fell to 0 before 6.5 hours of sunlight exposure, while the solid reference standard of this disclosure maintained signal intensity for the duration of the test.

FIG. 2 is a graph depicting results of repeated analysis of a PMMA-based standard of this disclosure containing 200 ppb of 2,9,16,23-tetrakis(2,5-di-tert-butyl-4-methoxyphenoxy)phthalocyanine in a laser diode-based fluorometer (638 nm, 40 mW excitation source). In FIG. 2, dotted lines ( . . . . . ) represent a control line at ±2% of mean signal, and dashed lines (-----) represent a control line at ±5% of mean signal. Similarly to the sunlight exposure testing of FIG. 1, the phthalocyanine doped PMMA of this disclosure was shown to be highly stable to repeated interrogations with a 638 nm laser diode in a field based LSX fluorescence analyzer, as shown in FIG. 2.

Example 2 demonstrates that the herein disclosed PMMA-based solid reference standards prepared using milder azo-based initiators are stable in direct sunlight and further are not degraded by thousands of analyses in a laser diode-based fluorescence analyzer, for example a field analyzer of the LSX platform. Conventional solvent-based (e.g., liquid) standards of the sample fluorophore are not stable under these conditions.

One of the advantages this disclosure is that the solid reference standards are compatible with the specific fluorophores used as fuel markers that are compatible with the LSX platform, available from Authentix of Addison, TX.

As discussed herein, conventional catalysts used in PMMA synthesis, such as benzoyl peroxide, can be incompatible with the fluorophores of interest (e.g., those comparable with the LSX platform). As discussed in Comparative Example 1, attempts to polymerize MMA with the fluorophores of interest resulted in no marker being detectable in the PMMA post polymerization using benzoyl peroxide. Without being limited by theory, the benzoyl peroxide radicals may have degraded the fluorophore during the polymerization reaction. Using the milder azo-based initiators, according to this disclosure, can be utilized to successfully incorporate the (e.g., phthalocyanine-based) fluorophores in the PMMA matrix. Examples of suitable azo-based initiators include but are not limited to 1,1′-azobis(cyclohexanecarbonitrile) (ABCN); azobisisobutyronitrile (AIBN); 2,2′-Azobis (2,4 dimethylvaleronitrile) (ABVN); 2,2′-Azobis(2-methylbutyronitrile); 2,2′-Azobis(4-methoxy-2,4-dimethylvaleronitrile); 4,4′-Azobis(4-cyanovaleric acid); or combinations thereof.

In embodiments, rather than creating a solid solution of the fluorophore in PMMA by dissolving the fluorophore of interest in the MMA directly and subsequently polymerizing the solution, the one or more fluorophore(s) can be compounded into pre-polymerized PMMA pellets directly. In such embodiments, the fluorophore doped PMMA pellets (e.g., mixed product) can subsequently be injection molded. This method can enable a cost-effective route to produce the fluorescence spectroscopy reference standards in volume.

The solid reference standards of this disclosure can provide enhanced safety and/or facilitated shipping relative to conventional liquid reference standards. The hydrophobic nature of the fluorophores can prohibit their dissolution in water and therefore, to create liquid reference standards, it is necessary to dissolve them in organic solvents. Solvents typically utilized for this purpose, including toluene, xylenes, trimethylbenzene, and the like, have toxicity levels that greatly exceed that of the fluorophore. Similarly, these solvents can also possess enhanced flammability and flash points, which can limit the options for shipping (e.g., restricted air shipping) and/or can significantly increase the cost of transportation thereof, when considered dangerous goods. The PMMA can pose no safety hazard to personnel handling same, while liquids utilized in some conventional liquid reference standards can pose safety hazards.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

### Additional Disclosure

The following are non-limiting, specific embodiments in accordance with the present disclosure:

In a first embodiment, a method comprises: preparing a reference material for fluorescence spectroscopy by: impregnating or otherwise placing one or more fluorophores into a solid PMMA matrix.

A second embodiment can include the method of the first embodiment, comprising impregnating or otherwise placing the one or more fluorophores into the solid PMMA matrix by: melt mixing (e.g., extruding, melt compounding) a powder of each of the one or more fluorophores with the solid PMMA matrix to provide a mixed product comprising a homogeneous distribution of the one or more fluorophores in the PMMA; and injection molding the mixed product to provide the reference material having a final shape.

A third embodiment can include the method of the second embodiment, wherein the final shape comprises a cuvette shape.

A fourth embodiment can include the method of the second or third embodiment, wherein the mixed product comprises pellets.

A fifth embodiment can include the method of any one of the second to fourth embodiments, wherein melt mixing further comprises: melt mixing the solid PMMA matrix and an amount of each powder of the one or more fluorophores to provide an intermediate product having a first concentration of the one or more fluorophores, wherein the first concentration is greater than a concentration of the one or more fluorophores in the reference standard; and melt mixing the intermediate product with additional solid PMMA matrix one or more times to provide the mixed product having the concentration of the one or more fluorophores in the reference standard, and the homogeneous distribution of the one or more fluorophores in the PMMA.

A sixth embodiment can include the method of any one of the second to fifth embodiments, wherein the reference standard comprises at least two (e.g., different) fluorophores.

A seventh embodiment can include the method of the sixth embodiment, wherein melt mixing comprises: concomitantly melt mixing (e.g., extruding) a powder of each of the two or more fluorophores with the solid PMMA matrix to provide the mixed product comprising the homogeneous distribution of the two or more fluorophores in the PMMA (e.g., having a different spectral window).

An eighth embodiment can include the method of the sixth or seventh embodiment, wherein melt mixing comprises: providing a first mixed product comprising a homogeneous distribution of a first of the two or more fluorophores in the PMMA; providing a second mixed product comprising a homogeneous distribution of a second of the two or more fluorophores in the PMMA; and melt mixing the first mixed product and the second mixed product and optionally additional solid PMMA matrix (e.g., virgin PMMA) to provide the mixed product comprising the homogeneous distribution of the two or more fluorophores in the PMMA.

A ninth embodiment can include the method of the eighth embodiment further comprising: providing the first mixed product by melt mixing (e.g., extruding) a powder of a first of the two or more fluorophores with the solid PMMA matrix to provide the first mixed product; and providing the second mixed product by melt mixing a powder of a second of the two or more fluorophores with the solid PMMA matrix to provide a second mixed product.

A tenth embodiment can include the method of the ninth embodiment further comprising: calibrating a fluorescence spectroscopy instrument by: exciting the fluorescence spectroscopy reference material with energy emitted form an excitation source of the fluorescence spectroscopy instrument, and detecting, with the fluorescence spectroscopy instrument, emission of electromagnetic radiation at two or more wavelengths between 600-900 nm from the excited fluorescence spectroscopy reference material.

An eleventh embodiment can include the method of any one of the first to tenth embodiments further comprising: calibrating a fluorescence spectroscopy instrument by: exciting the fluorescence spectroscopy reference material with energy emitted form an excitation source of the fluorescence spectroscopy instrument, and detecting, with the fluorescence spectroscopy instrument, emission of electromagnetic radiation at a wavelength between 600-900 nm from the excited fluorescence spectroscopy reference material.

A twelfth embodiment can include the method of any one of the first to eleventh embodiments, wherein impregnating or otherwise placing one or more fluorophores into the solid PMMA matrix further comprises polymerizing MMA in the presence of one or more fluorophores to form the solid PMMA matrix.

A thirteenth embodiment can include the method of the twelfth embodiment, wherein polymerizing further comprises initiating polymerization with an azo-based initiator.

A fourteenth embodiment can include the method of the thirteenth embodiment, wherein the azo-based initiator comprises 1,1′-azobis(cyclohexanecarbonitrile) (ABCN); azobisisobutyronitrile (AIBN); 2,2′-Azobis (2,4 dimethylvaleronitrile) (ABVN); 2,2′-Azobis(2-methylbutyronitrile); 2,2′-Azobis(4-methoxy-2,4-dimethylvaleronitrile); 4,4′-Azobis(4-cyanovaleric acid); or a combination thereof.

A fifteenth embodiment can include the method of any one of the twelfth to fourteenth embodiments further comprising dissolving the one or more fluorophores in the MMA prior to the polymerizing.

A sixteenth embodiment can include the method of any one of the twelfth to fifteenth embodiments, wherein the polymerizing yields the solid PMMA matrix having the one or more fluorophores distributed (e.g., uniformly) therein.

A seventeenth embodiment can include the method of any one of the twelfth to sixteenth embodiments, wherein the one or more fluorophores emit in the 600-900 nm range.

An eighteenth embodiment can include the method of any one of the first to seventeenth embodiment, wherein the one or more fluorophores comprise naphthalocyanines, violanthrones, aza-dipyrromethenes, or a combinations thereof.

A nineteenth embodiment can include the method of any one of the first to eighteenth embodiments, wherein the one or more fluorophores comprise phthalocyanine-based fluorophores.

A twentieth embodiment can include the method of any one of the first to nineteenth embodiments, wherein the one or more fluorophores comprise 2,9,16,23-tetrakis(2,5-di-tert-butyl-4-methoxyphenoxy)phthalocyanine.

A twenty first embodiment can include the method of any one of the first to twentieth embodiments, wherein the one or more fluorophores comprise Structure 1, Structure 2, Structure 3, Structure 4, or a combination thereof:

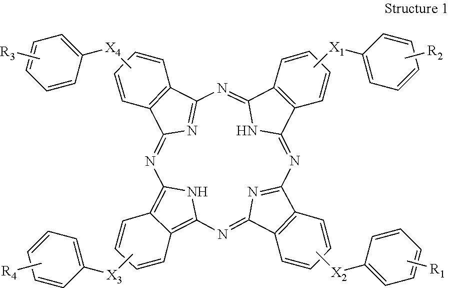

where X₁-X₄ is independently oxygen or sulfur and where R₁-R₄ is independently hydrogen, an alkyl group, a branched alkyl group, an alkoxy group, a branched alkoxy group;

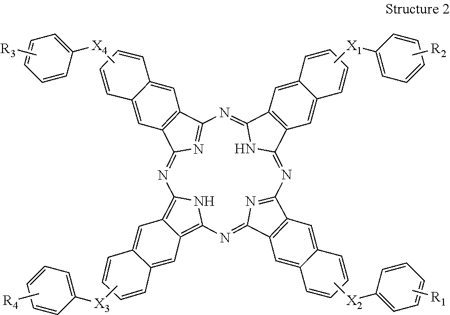

where X₁-X₄ is independently oxygen or sulfur and where R₁-R₄ is independently hydrogen, an alkyl group, a branched alkyl group, an alkoxy group, a branched alkoxy group;

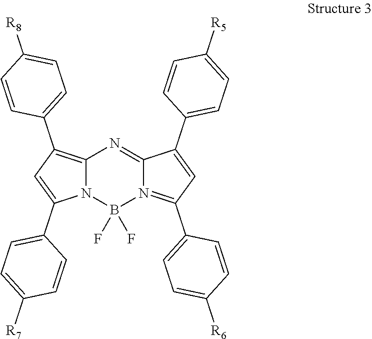

where R₅-R₈ is independently hydrogen, an alkyl group, a branched alkyl group, an alkoxy group, a branched alkoxy group, an amino group, an alkylamino group, a dialkylamino group, a thiol group, an alkylthio group, a branched alkylthio group, a halide group, or a nitro group;

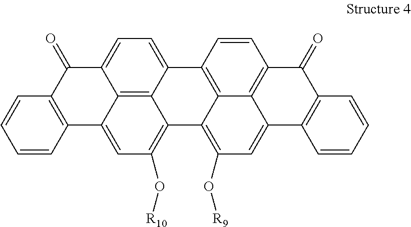

where R₉-R₁₀ is independently hydrogen, an alkyl group, a branched alkyl group, or a cycloalkyl group.

A twenty second embodiment can include the method of any one of the first to twenty first embodiments, wherein, after 1, 2, 3, or more weeks, the reference material maintains greater than about 90% of a fluorophore signal intensity thereof at time zero, wherein time zero is a time of preparing the reference standard.

In a twenty third embodiment, a fluorescence spectroscopy reference material prepared by the method of any of the first to twenty second embodiments.

In a twenty fourth embodiment, a fluorescence spectroscopy reference material comprises a solid PMMA matrix having one or more fluorophores distributed and sequestered therein.

In a twenty fifth embodiment, a method of calibrating a fluorescence spectroscopy instrument comprises: exciting, with energy emitted form an excitation source, a fluorescence spectroscopy reference material produced by: impregnating or otherwise placing one or more fluorophores into a solid PMMA matrix; and detecting, with the fluorescence spectroscopy instrument, emission of electromagnetic radiation at a wavelength between 600-900 nm from the excited fluorescence spectroscopy reference material.

A twenty sixth embodiment can include the method of the twenty fifth embodiment, wherein the excitation source comprises a laser or narrow band LED.

A twenty seventh embodiment can include the method of the twenty fifth or twenty sixth embodiment, wherein the excitation source comprises a 638 nm laser diode.

A twenty eighth embodiment can include the method of any one of the twenty fifth to twenty seventh embodiments, wherein the fluorescence spectroscopy instrument is a portable, field usable device suitable for use outside a laboratory environment.

A twenty ninth embodiment can include the method of any one of the twenty fifth to twenty eighth embodiments, comprising calibrating the fluorescence spectroscopy instrument in the field (i.e., not in a lab setting) for use in the field.

A thirtieth embodiment can include the method of any one of the first to twenty ninth embodiments, wherein impregnating or otherwise placing one or more fluorophores into the solid PMMA matrix further comprises: melt mixing (e.g., extruding, melt compounding) a powder of each of the one or more fluorophores with the solid PMMA matrix to provide a mixed product comprising a homogeneous distribution of the one or more fluorophores in the PMMA; and injection molding the mixed product to provide the reference material having a final shape.

In a thirty first embodiment, a calibrated spectroscopy instrument resulting from the method of any one of the twenty fifth to thirtieth embodiments.

In a thirty second embodiment, a method for analyzing a product comprises: sampling the product (e.g., a composition) to obtain a test sample, analyzing the test sample with the calibrated spectroscopy instrument, wherein the calibrated spectroscopy instrument was calibrated by: exciting, with energy emitted form an excitation source, a fluorescence spectroscopy reference material produced by: impregnating or otherwise placing one or more fluorophores into a solid PMMA matrix; and detecting, with the fluorescence spectroscopy instrument, emission of electromagnetic radiation at a wavelength between 600-900 nm from the excited fluorescence spectroscopy reference material.

A thirty third embodiment can include the method of the thirty second embodiment further comprising, based on the analyzing, (i) determining or authenticating a source of the product (e.g., for authentication purposes to detect counterfeit products), (ii) determining if the product is adulterated or diluted, or (iii) both (i) and (ii).

A thirty fourth embodiment can include the method of the thirty third embodiment, wherein the product is a marked fuel and wherein (i), (ii), or III) further comprises determining an amount of marker present in the marked fuel, a type of marker present in the marked fuel, or both.

A thirty fifth embodiment can include the method of any one of the thirty second to thirty fourth embodiments, wherein impregnating or otherwise placing one or more fluorophores into the solid PMMA matrix further comprises: melt mixing (e.g., extruding, melt compounding) a powder of each of the one or more fluorophores with the solid PMMA matrix to provide a mixed product comprising a homogeneous distribution of the one or more fluorophores in the PMMA; and injection molding the mixed product to provide the reference material having a final shape.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Ru, is disclosed, any number falling within the range is specifically disclosed. In particular, the following numbers within the range are specifically disclosed: R=R1+k*(Ru—R1), wherein k is a variable ranging from 1 percent to 100 percent with a 1 percent increment, i.e., k is 1 percent, 2 percent, 3 percent, 4 percent, 5 percent, . . . . . 50 percent, 51 percent, 52 percent, . . . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
preparing a reference material for fluorescence spectroscopy by:
impregnating or otherwise placing one or more fluorophores into a solid PMMA matrix.

2. The method of claim 1 comprising impregnating or otherwise placing the one or more fluorophores into the solid PMMA matrix by:
melt mixing a powder of each of the one or more fluorophores with the solid PMMA matrix to provide a mixed product comprising a homogeneous distribution of the one or more fluorophores in the PMMA; and
injection molding the mixed product to provide the reference material having a final shape.

3. The method of claim 2, wherein the final shape comprises a cuvette shape.

4. The method of claim 2, wherein melt mixing further comprises:
melt mixing the solid PMMA matrix and an amount of each powder of the one or more fluorophores to provide an intermediate product having a first concentration of the one or more fluorophores, wherein the first concentration is greater than a concentration of the one or more fluorophores in the reference standard; and
melt mixing the intermediate product with additional solid PMMA matrix one or more times to provide the mixed product having the concentration of the one or more fluorophores in the reference standard, and the homogeneous distribution of the one or more fluorophores in the PMMA.

5. The method of claim 4, wherein melt mixing comprises:
concomitantly melt mixing a powder of each of two or more fluorophores with the solid PMMA matrix to provide the mixed product comprising the homogeneous distribution of the two or more fluorophores in the PMMA.

6. The method of claim 5, wherein melt mixing comprises:
providing a first mixed product comprising a homogeneous distribution of a first of the two or more fluorophores in the PMMA;
providing a second mixed product comprising a homogeneous distribution of a second of the two or more fluorophores in the PMMA; and
melt mixing the first mixed product and the second mixed product and optionally additional solid PMMA matrix to provide the mixed product comprising the homogeneous distribution of the two or more fluorophores in the PMMA.

7. The method of claim 6 further comprising:
providing the first mixed product by melt mixing a powder of a first of the two or more fluorophores with the solid PMMA matrix to provide the first mixed product; and
providing the second mixed product by melt mixing a powder of a second of the two or more fluorophores with the solid PMMA matrix to provide a second mixed product.

8. The method of claim 1 further comprising:
calibrating a fluorescence spectroscopy instrument by:
exciting the fluorescence spectroscopy reference material with energy emitted form an excitation source of the fluorescence spectroscopy instrument, and
detecting, with the fluorescence spectroscopy instrument, emission of electromagnetic radiation at a wavelength between 600-900 nm from the excited fluorescence spectroscopy reference material.

9. The method of claim 1, wherein impregnating or otherwise placing one or more fluorophores into the solid PMMA matrix further comprises polymerizing MMA in the presence of one or more fluorophores to form the solid PMMA matrix.

10. The method of claim 9, wherein polymerizing further comprises initiating polymerization with an azo-based initiator.

11. The method of claim 1, wherein the one or more fluorophores comprise naphthalocyanines, violanthrones, aza-dipyrromethenes, or a combinations thereof.

12. The method of claim 1, wherein the one or more fluorophores comprise Structure 1, Structure 2, Structure 3, Structure 4, or a combination thereof: 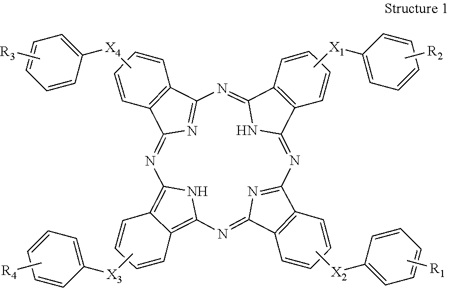
where X₁-X₄ is independently oxygen or sulfur and where R₁-R₄ is independently hydrogen, an alkyl group, a branched alkyl group, an alkoxy group, a branched alkoxy group; 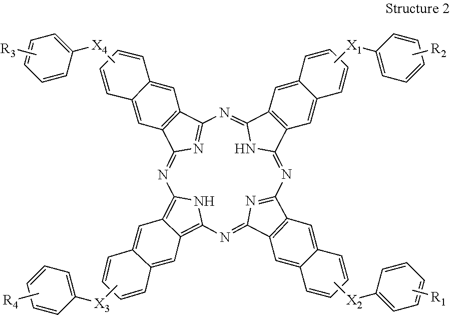
where X₁-X₄ is independently oxygen or sulfur and where R₁-R₄ is independently hydrogen, an alkyl group, a branched alkyl group, an alkoxy group, a branched alkoxy group; 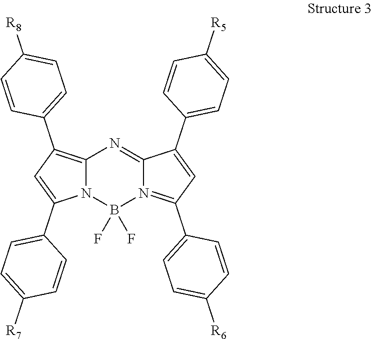
where R₅-R₈ is independently hydrogen, an alkyl group, a branched alkyl group, an alkoxy group, a branched alkoxy group, an amino group, an alkylamino group, a dialkylamino group, a thiol group, an alkylthio group, a branched alkylthio group, a halide group, or a nitro group; 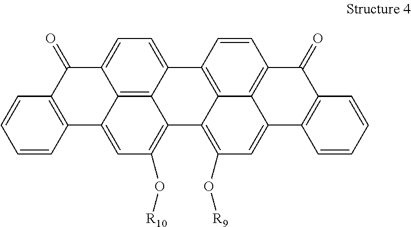
where R₉-R₁₀ is independently hydrogen, an alkyl group, a branched alkyl group, or a cycloalkyl group.

13. The method of claim 1, wherein, after at least three weeks, the reference material maintains greater than about 90% of a fluorophore signal intensity thereof at time zero, wherein time zero is a time of preparing the reference standard.

14. A fluorescence spectroscopy reference material comprising a solid PMMA matrix having one or more fluorophores distributed and sequestered therein.

15. A method of calibrating a fluorescence spectroscopy instrument, the method comprising:
exciting, with energy emitted form an excitation source, a fluorescence spectroscopy reference material produced by: impregnating or otherwise placing one or more fluorophores into a solid PMMA matrix; and
detecting, with the fluorescence spectroscopy instrument, emission of electromagnetic radiation at a wavelength between 600-900 nm from the excited fluorescence spectroscopy reference material.

16. The method of claim 15, wherein impregnating or otherwise placing one or more fluorophores into the solid PMMA matrix further comprises:
melt mixing a powder of each of the one or more fluorophores with the solid PMMA matrix to provide a mixed product comprising a homogeneous distribution of the one or more fluorophores in the PMMA; and
injection molding the mixed product to provide the reference material having a final shape.

17. A method for analyzing a product, the method comprising:
sampling the product to obtain a test sample,
analyzing the test sample with the calibrated spectroscopy instrument, wherein the calibrated spectroscopy instrument was calibrated by:
exciting, with energy emitted form an excitation source, a fluorescence spectroscopy reference material produced by: impregnating or otherwise placing one or more fluorophores into a solid PMMA matrix; and
detecting, with the fluorescence spectroscopy instrument, emission of electromagnetic radiation at a wavelength between 600-900 nm from the excited fluorescence spectroscopy reference material.

18. The method of claim 17 further comprising, based on the analyzing, (i) determining or authenticating a source of the product (e.g., for authentication purposes to detect counterfeit products), (ii) determining if the product is adulterated or diluted, or (iii) both (i) and (ii).

19. The method of claim 18, wherein the product is a marked fuel and wherein (i), (ii), or III) further comprises determining an amount of marker present in the marked fuel, a type of marker present in the marked fuel, or both.

20. The method of claim 17, wherein impregnating or otherwise placing one or more fluorophores into the solid PMMA matrix further comprises:
melt mixing a powder of each of the one or more fluorophores with the solid PMMA matrix to provide a mixed product comprising a homogeneous distribution of the one or more fluorophores in the PMMA; and
injection molding the mixed product to provide the reference material having a final shape.
